(19) United States
(12) Patent Application Publication
(10) Pub. No.: US 2007/0292155 A1
(43) Pub. Date: Dec. 20, 2007

(54) FIXING DEVICE AND FIXING METHOD

(75) Inventor: Akihiko Kida, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/764,861

(22) Filed: Jun. 19, 2007

(30) Foreign Application Priority Data
Jun. 19, 2006 (JP) 2006-168415

(51) Int. Cl. G03G 15/20

(52) U.S. Cl. 399/69

(57) ABSTRACT

There is provided a temperature control technique capable of satisfactorily reducing the flicker level in a fixing device using a plurality of heater lamps.

Two heater lamps for heating a heat roller 10 are provided inside the heat roller 10. One is a heater lamp 11 for mainly heating the center area of the heat roller 10, and the other is a heater lamp 12 having heat supply characteristics to mainly heat both end areas of the heat roller 10. A controller 21 controls the lighting timing of the heater lamps to obtain optimum lighting timing both in the copying time and stand-by time.

### BACKGROUND OF THE INVENTION

1. Field of the Invention

The present invention relates to a temperature control technique in a fixing device.

2. Description of the Related Art

A fixing device is provided in an image forming apparatus such as a printer or an MFP (multi-function peripherals) and is configured to heat-fix a toner image that has been transferred onto a recording paper. The fixing device typically has, in a heat roller, a heater lamp for heat-up and heat retention disposed near the contact side between the heat roller and recording paper and a heater lamp for heat-up disposed away from the contact side between the heat roller and recording paper. Among fixing devices having such a configuration, there is known a fixing device in which both the two heater lamps are turned on during the time period from power-on (at the time of warm-up) until the surface temperature of the heat roller reaches a predetermined fixable temperature to heat the heat roller, thereby allowing the surface temperature of the heat roller to reach a predetermined fixable temperature at short times.

In the fixing device having the configuration described above, temperature operation is performed such that the heater lamp for heat-up and heat retention is turned on when the surface temperature of the heat roller decreases to less than a predetermined fixable temperature and is turned off when the surface temperature of the heat roller exceeds the predetermined fixable temperature, thereby allowing the surface temperature of the heat roller to thereby maintain the surface temperature of the heat roller at the predetermined fixable temperature (refer to, e.g., Jpn. Pat. Appln. Laid-Open Publication No. 10-333487).

In the above conventional fixing device, the two heater lamps are turned on simultaneously at power-on time, making it possible to rise the temperature of the surface layer of the heat roller to a predetermined fixable temperature. However, simultaneous supply of power to the two heater lamps at power-on time may cause flicker.

### SUMMARY OF THE INVENTION

An object of the embodiment of the present invention is to provide a temperature control technique capable of satisfactorily reducing the flicker level in a fixing device using a plurality of heater lamps.

To solve the above problem, according to a first aspect of the present invention, there is provided a fixing device that is provided in an image forming apparatus and configured to heat-fix a toner image formed on a medium, comprising: a heat roller that is brought into contact with a medium on which a toner image has been formed; a plurality of heat sources that are provided inside the heat roller and configured to heat different areas with respect to the rotary axis direction of the heat roller; a plurality of temperature detection sections that are disposed at different positions from each other with respect to the rotary axis direction of the heat roller and detect the surface temperature of the heat roller at their respective positions; and a controller that individually controls the heat start timing of the plurality of heat sources based on the temperatures detected by the temperature detection sections.

Further, according to a second aspect of the present invention, there is provided a fixing device that is provided in an image forming apparatus and configured to heat-fix a toner image formed on a medium, comprising: a heat roller that is brought into contact with a medium on which a toner image has been formed; a plurality of heating means that are provided inside the heat roller and configured for heating different areas with respect to the rotary axis direction of the heat roller; a plurality of temperature detecting means that are disposed at different positions from each other with respect to the rotary axis direction of the heat roller for detecting the surface temperature of the heat roller at their respective positions; and a controlling means for individually controlling the heat start timing of the plurality of heating means based on the temperatures detected by the temperature detecting means.

Further, according to a third aspect of the present invention, there is provided a fixing method that uses a fixing device comprising a heat roller that is brought into contact with a medium on which a toner image has been formed, a plurality of heat sources that are provided inside the heat roller and configured to heat different areas with respect to the rotary axis direction of the heat roller, and a plurality of temperature detection sections that are disposed at different positions from each other with respect to the rotary axis direction of the heat roller and detect the surface temperature of the heat roller at their respective positions, to heat-fix a toner image formed on a medium, the method comprising controlling the heat start timing of the plurality of heat sources based on the temperatures detected by the plurality of temperature detection sections.

### BRIEF DESCRIPTION OF THE DRAWINGS

FIG. 1 is a view showing an outline of a fixing device according to an embodiment of the present embodiment;

FIG. 2 is a block diagram showing a configuration of a heater control unit according to the embodiment of the present invention;

FIG. 3 is a flowchart showing a protection control for preventing the excessive temperature rise at power-on time according to the embodiment of the present invention;

FIG. 4 is a view showing a temperature control sequence according to the embodiment of the present invention;

FIG. 5 is a view showing lamp-on waiting time according to the embodiment of the present invention;

FIG. 6 is a view showing an example of lighting timing of the lamp according to the embodiment of the present invention; and

FIG. 7 is a view showing a relationship between lighting timing and Pst level.

### DETAILED DESCRIPTION OF THE PREFERRED EMBODIMENTS

An embodiment of the present invention will be described with reference to the accompanying drawings. In this embodiment, a fixing device according to the present invention is applied to a digital MFP (image forming apparatus) that performs image forming processing according to an electrophotographic system.

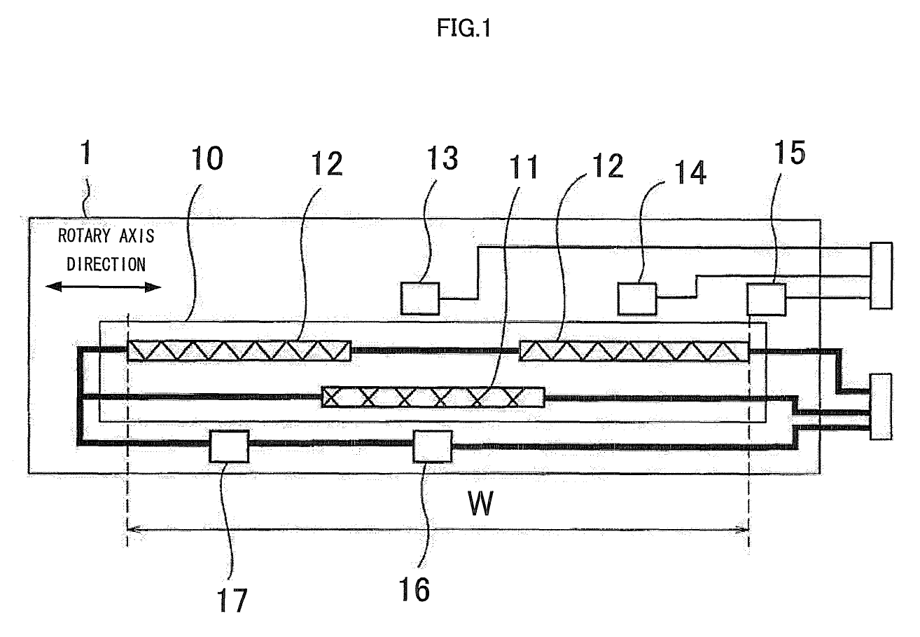

FIG. 1 is a cross-sectional view for schematically explaining a configuration of a fixing device 1 according to the present embodiment. A heat roller 10 is a cylindrical heater that is brought into contact with a recording medium on which a toner image has been formed to thereby heat-fix the toner image onto the recording medium. Two heater lamps for heating the heat roller 10 are provided inside the heat roller 10. One is a heater lamp 11 (hereinafter, referred to as “center lamp 11”) serving as a first heat source (first heating means) having heat supply characteristics to mainly heat a predetermined area in the vicinity of the center of the heat roller 10 in the rotary axis direction thereof, and the other is a heater lamp 12 (hereinafter, referred to as “side lamp 12”) serving as a second heat source (second heating means) having heat supply characteristics to mainly heat a predetermined area in the vicinity of both ends of the heat roller 10 in the rotary axis direction thereof. As described above, the first and second heat sources heat different areas in the rotary axis direction of the heat roller 10.

In the present embodiment, the total amount of electric energy consumed by the center lamp 11 and side lamp 12 is substantially equal to the available electric energy at power-on time of the digital MFP, and the electric energy of the center lamp 11 and that of the side lamp 12 is equal to each other.

A maximum paper feed width W shown in FIG. 1, which is set to a predetermined value at the center of the heat roller 10, represents a width within which a toner image that has been transferred onto a paper can be fixed by the heat of the heat roller 10. The maximum paper feed width W is set smaller than the length of the heat roller 10, so that non-paper-feed areas are formed on both sides of the maximum paper feed width W of the heat roller 10.

Further, a plurality of temperature detection sections (plurality of temperature detecting means) are provided inside the heat roller 10. The temperature detection sections include a thermistor 13 (hereinafter, referred to as “center thermistor 13”) for detecting the temperature of the center area of the surface of the heat roller 10, a thermistor 14 (hereinafter, referred to as “side thermistor 14”) for detecting the temperature of the end area thereof, and a thermistor 15 (hereinafter, referred to as “edge thermistor 15”) for detecting the temperature of the non-paper-feed area. As described above, the center thermistor 13, side thermistor 14, and edge thermistor 15 are disposed at different positions form each other with respect to the rotary axis direction of the heat roller 10 and detect the surface temperature of the heat roller 10 at their respective positions.

Further, thermostats 16 and 17 are disposed respectively at the center portion of the heat roller 10 which is heated by the center lamp 11 and at the end portion thereof which is heated by the side lamp 12. When detecting excessive temperature rise, the thermostats 16 and 17 stop current application so as to protect the fixing device.

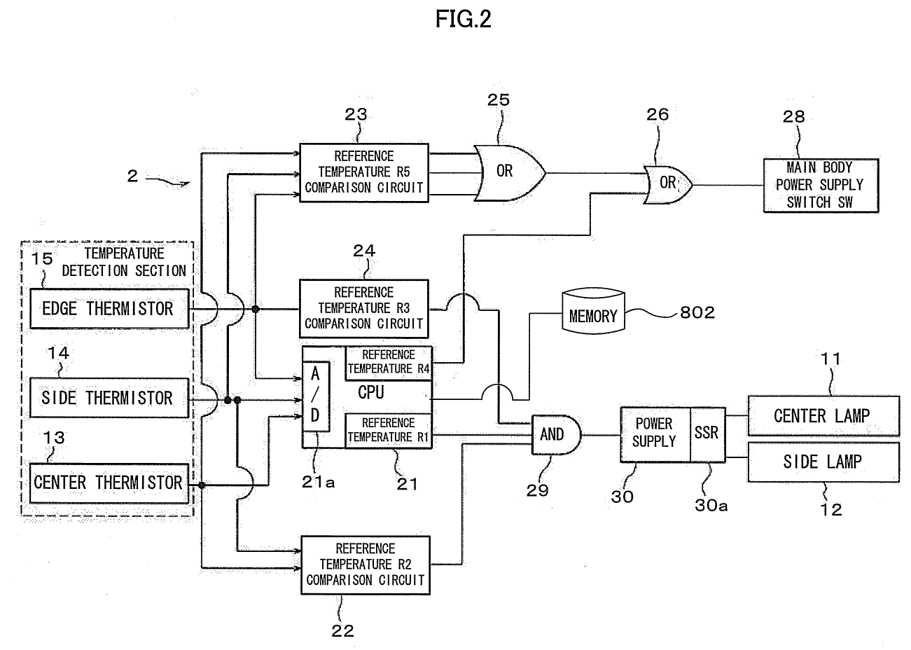

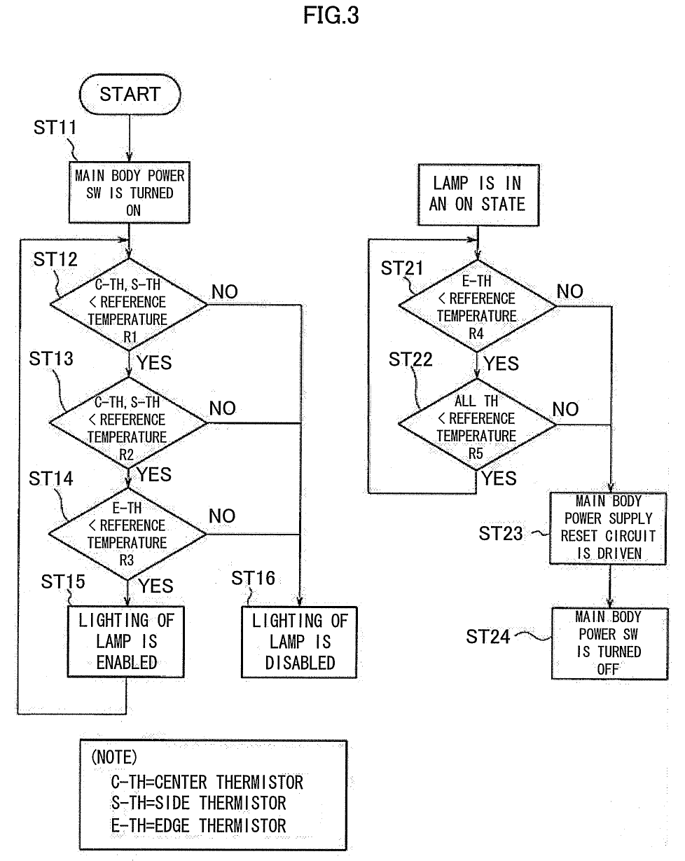

FIG. 2 is a block diagram showing a control configuration of a heater control unit 2 of the fixing device 1 according to the present embodiment. FIG. 3 is a flowchart showing a control flow (fixing method according to the present embodiment) for preventing the excessive temperature rise at power-on time of the digital MFP.

As shown in FIG. 2, the outputs of the center thermistor 13 and side thermistor 14 are input to a controller (controlling means) 21, a reference temperature R2 comparison circuit 22 and a reference temperature R5 comparison circuit 23. The output of the edge thermistor 15 is input to a controller 21, a reference temperature R3 comparison section 24 and reference temperature R5 comparison circuit 23.

The controller 21 includes an A/D section 21a, a CPU, a not shown ROM, a storage section, a clock section, and the like, and the CPU which is a controlling means for overall control of the digital MFP executes various processing according to a control program (including image fixing program) stored in the ROM or various settings stored in the storage section or the like. The clock section generates time information, and the CPU uses the time information to measure the time for a predetermined time period.

The ROM stores reference temperature R1, reference temperature R4, and various control programs that the CPU executes, and storage section stores various setting times to be described later. The A/D section 21a converts an analog signal representing the temperature detected by the side thermistor 14 and edge thermistor 15 into a digital signal.

The abovementioned control programs include a control program that compares the temperatures detected by the center thermistor 13, side thermistor 14, and edge thermistor 15 which have been converted into digital signals by the A/D section 21a with the reference temperatures R1 and R4.

If the comparison result shows that all the detection temperatures of the thermistors 13, 14 and 15 are within the range of reference temperature R1, the CPU delivers an output signal “1” to an AND gate 29. If any one of the detection temperatures of the thermistors 13, 14 and 15 is out of the range of reference temperature R1, the CPU delivers an output signal “0” to the AND gate 29. If the comparison result shows that all the detection temperatures of the thermistors 13, 14 and 15 are within the range of reference temperature R4, the CPU of the control section 21 delivers an output signal “1” to an OR gate 26. If any one of the detection temperatures of the thermistors 13, 14 and 15 is out of the range of reference temperature R4, the CPU delivers an output signal “0” to the OR gate 26.

The reference temperature R2 comparison circuit 22 compares output signals from the center thermistor 13 and side thermistor 14 with a reference temperature R2. If the comparison result shows that the output signals from the center thermistor 13 and side thermistor 14 are within the range of reference temperature R2, the reference temperature R2 comparison circuit 22 delivers an output signal “1” to the AND gate 29. If the comparison result shows that the output signals from the center thermistor 13 and side thermistor 14 are out of the range of reference temperature R2, the reference temperature R2 comparison circuit 22 delivers an output signal “0” to the AND gate 29. The reference temperature R3 comparison circuit 24 compares an output signal from the edge thermistor 15 with a reference temperature R3. If the comparison result shows that the output signal from the edge thermistor 15 is within the range of reference temperature R3, the reference temperature R3 comparison circuit 24 delivers an output signal “1” to the AND gate 29. If the comparison result shows that the output signal from the edge thermistor 15 is out of the range of reference temperature R3, the reference temperature R3 comparison circuit 24 delivers an output signal “0” to the AND gate 29. The AND gate 29 performs AND operations on the basis of outputs from the control section 21, reference temperature R2 comparison circuit 22 and reference temperature R3 comparison circuit 24. For example, if the detection temperatures of the center thermistor 13 and side thermistor 14 are within the ranges of reference temperatures R1 and R2 and the detection temperature of the edge thermistor 15 is within the range of reference temperature R3, the AND gate 29 delivers an output signal “1” to a power supply 30.

The power supply 30 supplies power to the center lamp 11 and side lamp 12. The power supply 30 includes an SSR (Solid-State Relay) 30a. When receiving, for example, an output signal “1” from the AND gate 29, the power supply 30 supplies power to the center lamp 11 and side lamp 12.

The CPU constituting the controller 21 executes various processing in the fixing device based on control programs stored in the ROM as well as implements various functions by executing a program stored in a memory 802. A memory 802, which is constituted by a ROM or RAM, stores various information and programs used in the fixing device.

As described above, the controller 21 individually controls the heat start timing of the plurality of heating means based on the temperatures detected by the center thermistor 13, side thermistor 14, and edge thermistor 15.

More specifically, as shown in FIG. 3, a main body power switch (SW) 28 is tuned on (ST1) and, if the comparison result satisfies all the conditions below: the detection temperatures of the center thermistor 13 and side thermistor 14 are within the range of reference temperature R1 (YES in ST12); detection temperatures of the center thermistor 13 and side thermistor 14 are within the range of reference temperature R2 set in the controller 21 (YES in ST13); and detection temperature of the edge thermistor 15 is within the range of reference temperature R3 (YES in ST14), lighting of the center lamp 11 and side lamp 12 is enabled (ST15).

The reference temperature R5 comparison circuit 23 compares temperature signals output from the center thermistor 13, side thermistor 14 and edge thermistor 15 (i.e., signals representative of temperatures detected by center thermistor 13, side thermistor 14 and edge thermistor 15) with a reference signal (second protection control temperature) R5. If the comparison result shows that the temperature detected by the center thermistor 13 (side thermistor 14, edge thermistor 15) is out of the range of reference temperature R5, the reference temperature R5 comparison circuit 23 delivers a corresponding output signal “1” to the OR gate 25. If the comparison result shows that the temperature detected by the center thermistor 13 (side thermistor 14, edge thermistor 15) is within the range of reference temperature R5, the reference temperature R5 comparison circuit 23 delivers a corresponding output signal “0” to the OR gate 25. The above comparison results are delivered to an OR gate 26 as three output signals corresponding to the thermistors 13, 14 and 15.

The OR gate 26 performs an OR operation on the basis of outputs from the control section 21 and reference temperature R5 comparison circuit 23. If one of the output from the control section 21 and the output from the reference temperature R5 comparison circuit 23 is “1”, the OR gate 26 delivers an output signal “1” to a reset circuit 27. The reset circuit 27 is a circuit for turning off power that is supplied by turn-on of a main body power supply SW 28. If the OR gate 26 outputs “1”, the reset circuit 27 resets and turns off the power to the digital MFP.

More specifically, as shown in FIG. 3, if the detection temperature of the edge thermistor 15 has exceeded the reference temperature R4 set in the controller 21 (NO in ST21), or if the detection temperature of the center thermistor 13, side thermistor 14, or edge thermistor 15 has exceeded the reference temperature R5 (NO in ST21), the reset circuit 27 is driven (ST23) to turn off the power to the digital MFP (ST24).

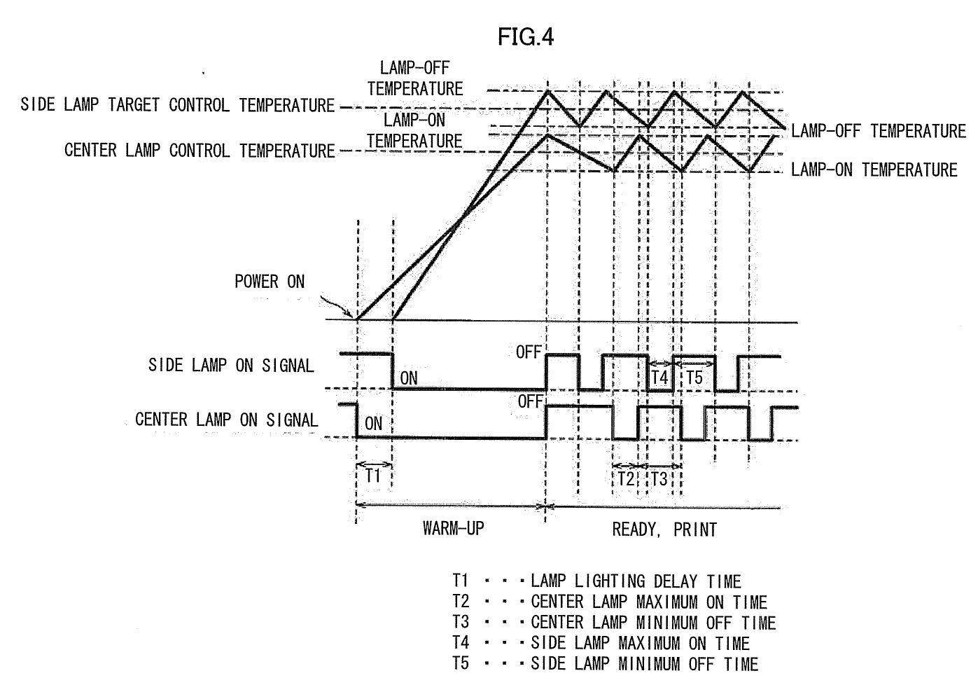

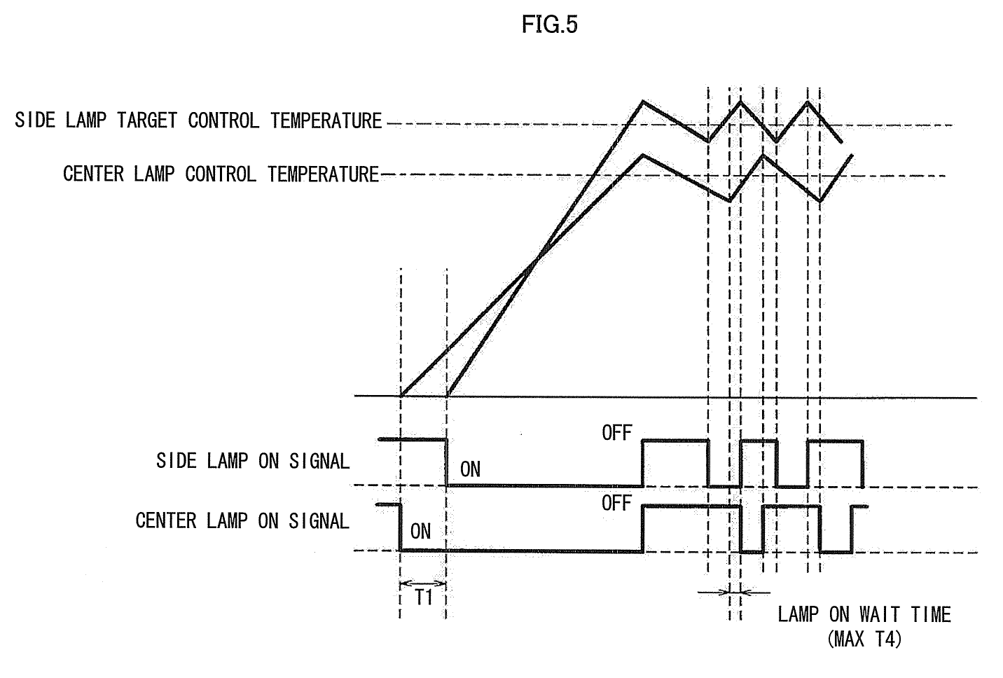

Next, in the heater control unit 2 of the fixing device 1 having such a protecting function to prevent excessive temperature rise, control operation that the controller 21 performs when power can be supplied to the center lamp 11 and side lamp 12 will be described with reference to FIGS. 4 and 5. Note that the controller 21 is configured to control the SSR 30a inside the power supply 30 to thereby control the lighting and extinguishing of the center lamp 11 and side lamp 12 so as to start or stop heating. Further, the controller 21 stores, in its storage section, a control temperature range within which a toner image can be fixed by the heat of the heat roller 10. For example, the control temperature range is set such that when the temperature of the heat roller 10 is increased by 2° C. from a target control temperature, the lamps are turned off, and when the temperature of the heat roller 10 is decreased by 2° C. from the target control temperature, the lamps are turned on.

As shown in FIG. 4, when an operator turns on the main body power SW 28, the controller 21 starts warm-up of the digital MFP. At the same time, the controller 21 starts heating the center lamp 11 and, after lamp lighting delay time T1 has elapsed, starts heating the side lamp 12 (warm-up heat controlling means). The lamp lighting delay time T1 is previously set in the storage section of the controller 21.

When the detection temperatures of the center thermistor 13 and side thermistor 14 have exceeded the control temperature range respectively, the controller 21 stops the heating of the center lamp 11 and side lamp 12. The control during the warm-up time is thus performed. After that, the digital MFP enters stand-by state and printing state.

At the stand-by state and printing state, the controller 21 compares the detection results of the respective thermistors 13, 14, and 15 with the control temperature range and, according to the comparison results, outputs a lamp-on signal to the SSR inside the power supply. When heating is performed by the lighting of one of the center and side lamps 11 and 12, the controller 21 puts the other lamp into a stand-by state so as to maintain the surface temperature of the heat roller 10 at the control temperature range.

The control for maintaining the surface temperature of the heat roller 10 is performed as follows. When the temperature detected by the center thermistor 13 has become not more than the lamp-on temperature, the controller 21 starts heating the center lamp 11 and, at the same time, starts counting maximum on time T2 set in the storage section. The maximum on time T2 is defined as the maximum time period during which the heating of the center lamp 11 is continued.

When the detection temperature of the center thermistor 13 has exceeded the lamp-off temperature, or when the maximum on time has elapsed, the controller 21 stops the heating of the center lamp 11 and, at the same time, starts counting minimum off time T3 set in the storage section. The minimum off time T3 is defined as the minimum time period during which the heating of the center lamp 11 is stopped.

Further, when the temperature detected by the side thermistor 14 has become not more than the lamp-on temperature, the controller 21 starts heating the side lamp 12 and, at the same time, starts counting maximum on time T4 set in the storage section. The maximum on time T4 is defined as the maximum time period during which the heating of the side lamp 12 is continued. When the detection temperature of the side thermistor 14 has exceeded the lamp-off temperature, or when the maximum on time has elapsed, the controller 21 stops the heating of the side lamp 12 and, at the same time, starts counting minimum off time T5 set in the storage section. The minimum off time T5 is defined as the minimum time period during which the heating of the side lamp 12 is stopped.

The reason for providing the minimum off time T3 and minimum off time T5 after the heating of the center lamp 11 and side lamp 12 as described above is to prevent only one of the center and side lamps 11 and 12 from being continued to be heated.

Although the heating of both the center and side lamps 11 and 12 is not performed simultaneously in the above heating control, there exists a time period during which the heating of both the center and side lamps 11 and 12 is stopped. This is, for example, a case where, after one lamp is heated to reach its lamp-off temperature, the heating of the other lamp is started to reach its lamp-off temperature before the next lamp-on time of the one lamp comes. As described above, when heating is unnecessary, the controller 21 does not perform the heating of both the center and side lamps 11 and 12.

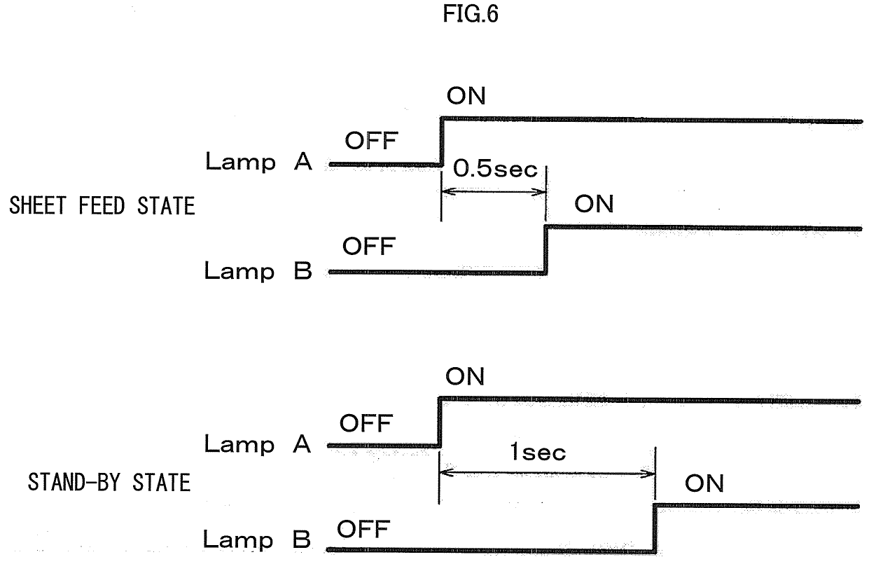

Further, as shown in FIG. 5, even when a request for starting the heating of the center lamp 11 is made during the heating of the side lamp 12, the controller 21 delays the start of the heating of the center lamp 11 until the heating of the side lamp 12 is stopped by the time represented by lamp-on wait time of FIG. 6 and starts heating the center lamp 11 after the stop of the heating of the side lamp 12.

The lamp-on wait time becomes maximum when a request for starting the heating of the center lamp 11 is made immediately after the start of the heating of the side lamp 12. In this case, the time length of the lamp-on wait time is equal to that of the maximum on time T4. Similarly, even when a request for starting the heating of the side lamp 12 is made during the heating of the center lamp 11, the controller 21 delays the start of the heating of the side lamp 12 until the heating of the center lamp 11 is stopped. The lamp-on wait time in this case becomes equal up to the maximum on time T2.

The lamp maximum on time (T2, T4) is set to not less than a value at which a single lighting operation allows the temperature of the heat roller 10 to rise from the lamp-on temperature to lamp-off temperature. Therefore, it is necessary to set an adequate length for the respective control times according to the lamp-off temperature and lamp-on temperature corresponding to the power consumption and target control temperature of each lamp.

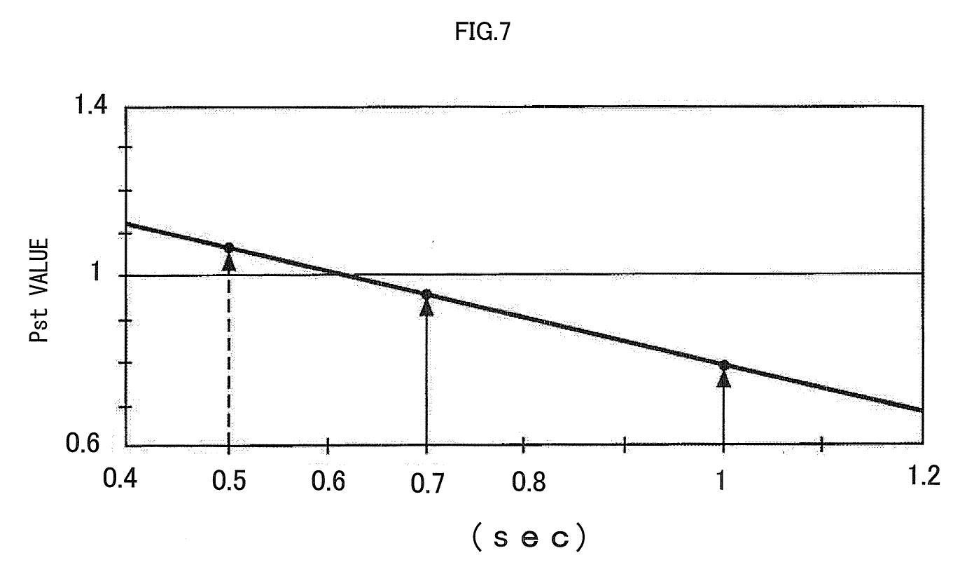

The on/off timing of the center lamp 11 and side lamp 12 in the present embodiment will be described with reference to FIGS. 6 and 7.

In the present invention, the on timing of the center and side lamps 11 and 12 can be controlled (changed) by the CPU. For example, as shown in FIG. 6, the controller 21 can change the on/off timing of the center and side lamps depending on the operating state of the digital MFP, i.e., whether printing operation is in a paper feed state (printing is being performed) or in a stand-by state.

FIG. 7 is a view showing a relationship between the lighting timing of both the center and side lamps 11 and 12 and Pst level. The Pst level mentioned here means the level of a Pst value used in flicker estimation according to IEC (International Electrotechnical Commission) specification.

As shown in FIG. 7, when the time period (“0.5 sec” and “1 sec” of FIG. 6 correspond to this time period) from the heat start timing of one of the center and side lamps 11 and 12 to the heat start timing of the other one of the lamps is set longer than 0.7 sec, the Pst value becomes less than 1. In light of this, in the present embodiment, the above time period is set to 1.0 sec in the stand-by state where it is possible to set the time period comparatively longer. In the paper feed state where on/off operations are frequently repeated, the time period is set to 0.7 sec which is shorter than in the stand-by state and at which the Pst value is reduced to not more than 1. With this control, the flicker level can be reduced.

By changing the lighting timing of the heater lamp depending on the operating state of the digital MFP (image forming apparatus), i.e., whether printing operation is in a paper feed state (printing is being performed) or in a stand-by state as described above, the flicker level can be reduced even in a fixing device provided with a plurality of heat sources having different heat radiation width.

The abovementioned processing (fixing method) performed in the fixing device is implemented by the controller (CPU) 21 executing an image fixing program stored in the memory 802.

In the present embodiment, there has been explained the case where the function for implementing the present invention is previously stored inside the device, but the present invention is not limited thereto, and a similar function may be downloaded from the network into the apparatus or a recording medium on which a similar function is stored is installed in the apparatus. The recording medium may be any form of recording medium such as CD-ROM which can store programs and is readable by the apparatus. The function which can be previously obtained through installing or downloading may be realized in cooperation with the OS (operating system) inside the apparatus.

Although an exemplary embodiment of the present invention has been shown and described, it will be apparent to those having ordinary skill in the art that a number of changes, modifications, or alterations to the invention as described herein may be made within the spirit and scope of the present invention.

As described above, according to the present invention, it is possible to provide a temperature control technique capable of satisfactorily reducing the flicker level in a fixing device using a plurality of heater lamps.

What is claimed is:

1. A fixing device that is provided in an image forming apparatus and configured to heat-fix a toner image formed on a medium, comprising:
a heat roller that is brought into contact with a medium on which a toner image has been formed;
a plurality of heat sources that are provided inside the heat roller and configured to heat different areas with respect to the rotary axis direction of the heat roller;
a plurality of temperature detection sections that are disposed at different positions from each other with respect to the rotary axis direction of the heat roller and detect the surface temperature of the heat roller at their respective positions; and
a controller that individually controls the heat start timing of the plurality of heat sources based on the temperatures detected by the temperature detection sections.

2. The fixing device according to claim 1, wherein
the plurality of heat sources include a first heat source for heating a predetermined area in the vicinity of the center of the heat roller in the rotary axis direction thereof and a second heat source for heating a predetermined area in the vicinity of both ends of the heat roller in the rotary axis direction thereof.

3. The fixing device according to claim 1, wherein
the controller sets the time period from the heat start timing of one of the first and second heat sources to heat start timing of the other one of the heat sources during print operation time in the image forming apparatus shorter than the time period from the heat start timing of one of the first and second heat sources to the heat start timing of the other one of the heat sources during a stand-by state of the image forming apparatus.

4. The fixing device according to claim 1, wherein
the controller sets the time period from the heat start timing of one of the first and second heat sources to the heat start timing of the other one of the heat sources during print operation time in the image forming apparatus to 0.7 sec and sets the time period from the heat start timing of one of the first and second heat sources to the heat start timing of the other one of the heat sources during the stand-by state of the image forming apparatus to 1.0 sec.

5. A fixing device that is provided in an image forming apparatus and configured to heat-fix a toner image formed on a medium, comprising:
a heat roller that is brought into contact with a medium on which a toner image has been formed;
a plurality of heating means that are provided inside the heat roller and configured for heating different areas with respect to the rotary axis direction of the heat roller;
a plurality of temperature detecting means that are disposed at different positions from each other with respect to the rotary axis direction of the heat roller for detecting the surface temperature of the heat roller at their respective positions; and
a controlling means for individually controlling the heat start timing of the plurality of heating means based on the temperatures detected by the temperature detecting means.

6. The fixing device according to claim 5, wherein
the plurality of heating means include a first heating means for heating a predetermined area in the vicinity of the center of the heat roller in the rotary axis direction thereof and a second heating means for heating a predetermined area in the vicinity of both ends of the heat roller in the rotary axis direction thereof.

7. The fixing device according to claim 5, wherein
the controlling means sets the time period from the heat start timing of one of the first and second heating means to the heat start timing of the other one of the heat sources during print operation time in the image forming apparatus shorter than that during a stand-by state of the image forming apparatus.

8. The fixing device according to claim 5, wherein
the controlling means sets the time period from the heat start timing of one of the first and second heating means to the heat start timing of the other one of the heat sources during print operation time in the image forming apparatus to 0.7 sec and sets the time period during the stand-by state of the image forming apparatus to 1.0 sec.

9. A fixing method that uses a fixing device comprising a heat roller that is brought into contact with a medium on which a toner image has been formed, a plurality of heat sources that are provided inside the heat roller and configured to heat different areas with respect to the rotary axis direction of the heat roller, and a plurality of temperature detection sections that are disposed at different positions from each other with respect to the rotary axis direction of the heat roller and detect the surface temperature of the heat roller at their respective positions, to heat-fix a toner image formed on a medium,
the method comprising controlling the heat start timing of the plurality of heat sources based on the temperatures detected by the plurality of temperature detection sections.

10. The fixing method according to claim 9, wherein
the plurality of heat sources include a first heat source for heating a predetermined area in the vicinity of the center of the heat roller in the rotary axis direction thereof and a second heat source for heating a predetermined area in the vicinity of both ends of the heat roller in the rotary axis direction thereof.

11. The fixing method according to claim 9, wherein
the fixing device is provided in an image forming apparatus, and
the time period from the heat start timing of one of the first and second heat sources to the heat start timing of the other one of the heat sources during print operation time in the image forming apparatus is set shorter than the time period from the heat start timing of one of the first and second heat sources to the heat start timing of the other one of the heat sources during a stand-by state of the image forming apparatus.

12. The fixing method according to claim 9, wherein
the fixing device is provided in an image forming apparatus, and
the time period from the heat start timing of one of the first and second heat sources to heat start timing of the other one of the heat sources during print operation time in the image forming apparatus is set to 0.7 sec, and time period from the heat start timing of one of the first and second heat sources to the heat start timing of the other one of the heat sources during the stand-by state of the image forming apparatus is set to 1.0 sec.
